(19) United States
(12) Patent Application Publication
(10) Pub. No.: US 2012/0130780 A1
(43) Pub. Date: May 24, 2012

(54) PROMOTION ANALYZER SYSTEM

(75) Inventors: Diganta Kumar Nayak, Irving, TX (US); Shankar Arumugavelu, Warren, NJ (US); Mahmoud Muhieddine Elassir, Mendham, NJ (US); Vivek Gurumurthy, Irving, TX (US); Velamur Srinivasan Sudharsan, Flower Mound, TX (US); Ravi Kanth Kalavagunta, Irving, TX (US); Rasesh Yogesh Maniar, The Colony, TX (US); Sunil Avadhanam, Irving, TX (US); Srinivasa Reddy Pakala, Irving, TX (US); Krishna P. Yemparala, Irving, TX (US)

(73) Assignee: VERIZON PATENT AND LICENSING, INC., Basking Ridge, NJ (US)

(21) Appl. No.: 12/954,066

(22) Filed: Nov. 24, 2010

(51) Int. Cl. G06Q 30/00

(52) U.S. Cl. 705/14.4

(57) ABSTRACT

A method performed by a server device, may include receiving information about a customer order, associated with a particular service or product provider, from an ordering system; determining whether the customer order is eligible for a promotion based on the received information where the promotion includes a reward to a customer for placing the customer order; and requesting balance information associated with the customer order from a billing system, when the customer order is eligible for the promotion. The method may further include receiving a balance amount, associated with the customer order, from the billing system; determining whether the balance amount is less than a balance threshold; and sending a message to a fulfillment system to fulfill the promotion, when the balance amount is less than the balance threshold.

### BACKGROUND INFORMATION

Providers of communication services continue to add new services and combine various services into bundles. For example, a service provider may offer telephone services, television services, and/or broadband Internet services. Furthermore, each type of service may be offered at multiple levels. For example, a television service may be offered as a basic service or as a premium service. As another example, broadband Internet services may be offered at multiple bandwidths and/or download speeds. Moreover, different types of services may be offered together in bundles at a discounted rate. Additionally, customers may be provided with various incentives to sign up for services. Keeping track of customer orders relating to offered communication services, or relating to incentives associated with particular services or combinations of services, may prove to be quite challenging.

### BRIEF DESCRIPTION OF THE DRAWINGS

FIG. 1 is a diagram illustrating an example of components of a system according to an implementation described herein;

FIG. 2 is a diagram illustrating example components of the promotion analyzer system of FIG. 1 according to an implementation described herein;

FIG. 3 is a diagram illustrating example functional components of the promotion analyzer system of FIG. 1 according to an implementation described herein;

FIG. 4A is a diagram of example fields that may be stored within the order database of FIG. 3 according to an implementation described herein;

FIG. 4B is a diagram of example fields that may be stored within the promotion database of FIG. 3 according to an implementation described herein;

FIGS. 5A-5C are flow diagrams illustrating a process of promotion analysis according to an implementation described herein;

FIG. 6 is a flow diagram illustrating a process for promotion accounting according to an implementation described herein; and

FIG. 7 is a diagram illustrating an example signal flow according to an implementation described herein.

### DETAILED DESCRIPTION OF PREFERRED EMBODIMENTS

The following detailed description refers to the accompanying drawings. The same reference numbers in different drawings identify the same or similar elements. Also, the following detailed description does not limit the invention.

An implementation described herein may relate to analyzing and tracking promotions associated with customer orders. For example, an implementation described herein may relate to analyzing an order with respect to promotion specifications to determine whether the customer associated with the order is eligible for a promotion, tracking changes in the order to determine whether the customer is still eligible for the promotion, checking a billing history associated with the order to determine whether the billing history satisfies the promotion specifications, fulfilling the promotion if the billing history satisfies the promotion specifications, and disqualifying the promotion if the billing history does not satisfy the promotion specifications. Furthermore, an implementation described herein may relate to sending messages to the customer while the promotion is being tracked to inform the customer of the status of the promotion.

An implementation described herein further relates to comparing a total number of customer orders with orders associated with particular promotion status types to determine whether all promotions are accounted-for.

A “promotion,” as the term is used herein, may refer to a free product and/or service, or a discount for a product and/or service, provided to a customer as a reward or an incentive for placing an order for services and/or products (e.g., wireless communication services, broadband Internet services, cable and/or digital television services, Voice over Internet Protocol (VoIP) services, etc.) associated with a service provider, a reward or incentive for upgrading an existing order to a higher level of services or products, a reward or incentive for signing a contract committing to a particular service for a particular length of time, or any combination thereof. The promotion may be provided by the service provider or may be provided by a third-party vendor based on an agreement with the service provider.

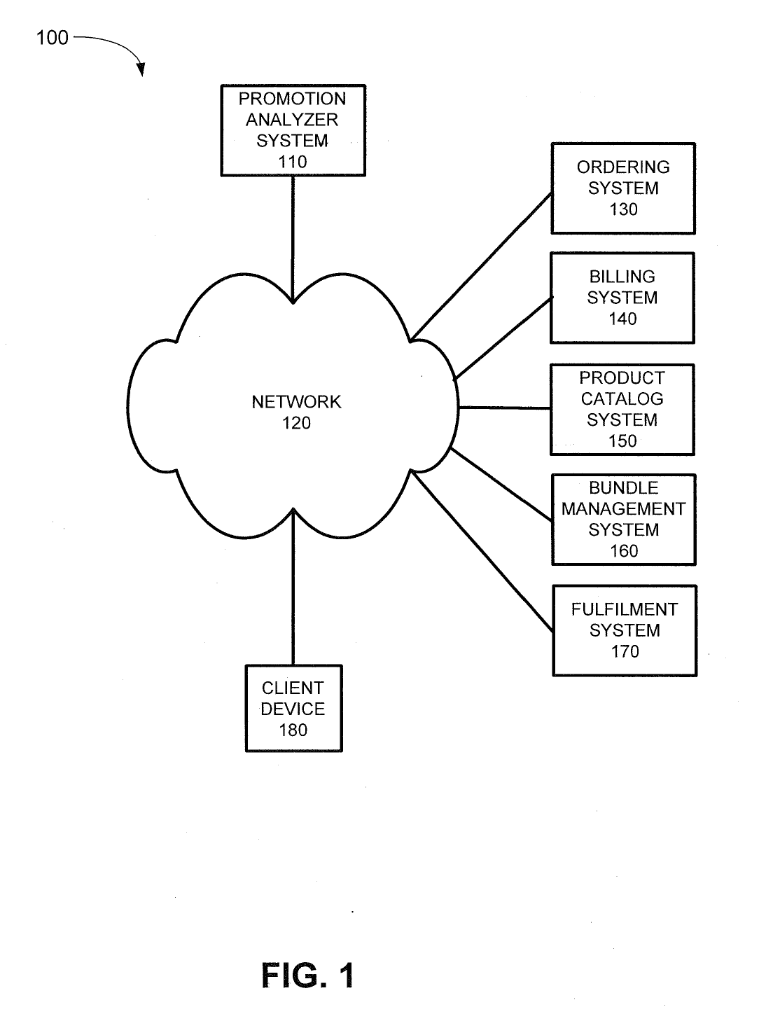

FIG. 1 is a diagram of a system 100 according to an implementation described herein. As shown in FIG. 1, system 100 may include a promotion analyzer system 110, a network 120, an ordering system 130, a billing system 140, a product catalog system 150, a bundle management system 160, a fulfillment system 170, and a client device 180.

Promotion analyzer system 110 may include one or more devices (e.g., server devices) that analyze and track promotions associated with customer orders. For example, promotion analyzer system 110 may receive information about customer orders from ordering system 130, may receive information about service and/or product bundles from bundle management system 160, and/or may receive promotion information from product catalog system 150. Promotion analyzer system 110 may analyze the received information and may determine whether a customer, associated with a customer order, is eligible for a promotion. When the customer is eligible for a promotion, promotion analyzer system 110 may track promotion requirements associated with the promotion, and when the promotion requirements have been satisfied, promotion analyzer system 110 may contact fulfillment system 170 to fulfill the promotion. For example, promotion analyzer system 110 may periodically track a balance of an account associated with the customer order, by communicating with billing system 140, to determine whether billing requirements associated with the promotion have been met.

Network 120 may include a circuit-switched network and/or a packet-switched network and may enable components of system 100 to communicate with each other. For example, network 120 may include one or more of a local area network (LAN), a wide area network (WAN), a metropolitan area network (MAN), a wireless network (e.g., a Code Division Multiple Access (CDMA) network, a general packet radio service (GPRS) network, and/or a Long Term Evolution (LTE) network), an ad hoc network, a public switched telephone network (PSTN), a subset of the Internet, any other network, or any combination thereof.

Ordering system 130 may include one or more devices (e.g., server devices) that manage customer orders associated with a particular service and/or product provider. For example, ordering system 130 may receive new customer orders and may provide information about the new customer orders to promotion analyzer system 110. Ordering system 130 may include, for example, a server that hosts a web page for purchasing services and/or products (e.g., cable television service, broadband Internet service, etc.). As another example, ordering system 130 may include a point of sale computer system, or may communicate with a point of sale computer system, which is located at a retail establishment that sells wireless communication devices.

Billing system 140 may include one or more devices (e.g., server devices) that manage accounts associated with customer orders associated with the particular service and/or product provider. For example, billing system 140 may receive information about a customer order from ordering system 130, may generate a bill when a billing cycle ends by calculating charges associated with a customer order, and may send the bill to the customer (e.g., send an electronic bill to client device 180). Billing system 140 may receive payments from the customer (e.g., receive an electronic payment) and may maintain a balance associated with the customer order. Billing system 140 may provide information about a billing history associated with the customer order (e.g., an outstanding balance) to promotion analyzer system 110.

Product catalog system 150 may include one or more devices (e.g., server devices) that manage available products and services associated with promotions. For example, product catalog system 150 may store information about particular promotions and may store particular requirements associated with particular promotions. Product catalog system 150 may provide promotion information to promotion analyzer system 110.

Bundle management system 160 may include one or more devices (e.g., server devices) that manage available service and/or product bundles associated with the particular service and/or product provider. For example, bundle management system 160 may store information about particular groupings of services and/or products, and/or particular levels of services and/or products. Additionally, bundle management system 160 may store information about whether a particular bundle includes a particular promotion along with information about the particular promotion. For example, when a customer subscribes to a basic television service together with a basic broadband Internet service, the customer may not be eligible for a promotion. However, when the customer upgrades to a premium television service, while keeping the subscription to the basic broadband Internet service, the customer may be eligible for a particular promotion.

Fulfillment system 170 may include one or more devices (e.g., server devices) that fulfill a particular promotion. For example, fulfillment system 170 may receive an indication from promotion analyzer system 110 that a particular promotion is to be fulfilled for a particular customer. In response to receiving the indication, fulfillment system 170 may perform one or more actions that conclude with the customer receiving the promotion. For example, fulfillment system 170 may instruct a third-party provider, associated with the promotion, to provide the promotion to the customer. Providing the promotion may include mailing a particular product (e.g., a gift card) to the customer via mail. As another example, fulfillment system 170 may apply a particular discount and/or rebate to an account associated with the customer by contacting billing system 140.

Client device 180 may include any device, associated with a customer, capable of receiving messages from promotion analyzer system 110. Client device 180 may include, for example, a mobile communication device, such as a mobile phone, a personal digital assistant (PDA), or a media playing device with communication capabilities; a desktop device, such as a personal computer or a workstation; a laptop computer; a telephone terminal; or any other communication device or combinations thereof. Client device 180 may receive messages from promotion analyzer system 110 via a wired (e.g., electrical and/or optical) or a wireless connection.

Although FIG. 1 shows example components of system 100, in other implementations, system 100 may include fewer components, different components, differently arranged components, and/or additional components than those depicted in FIG. 1. Alternatively, or additionally, one or more components of system 100 may perform one or more tasks described as being performed by one or more other components of system 100.

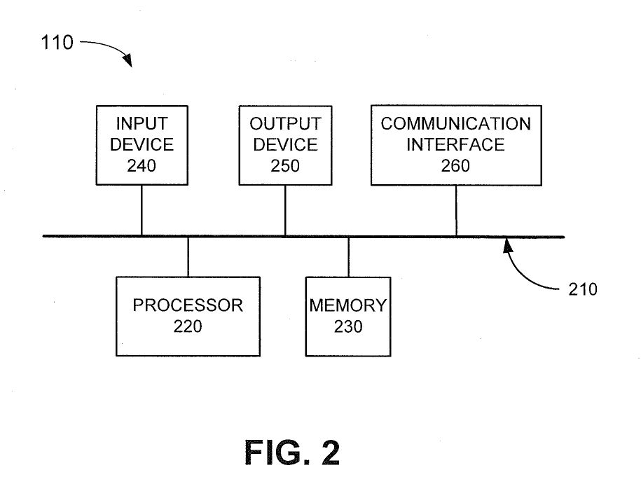

FIG. 2 is a diagram of example components of promotion analyzer system 110. As shown in FIG. 2, promotion analyzer system 110 may include a bus 210, a processor 220, a memory 230, an input device 240, an output device 250, and a communication interface 260.

Bus 210 may permit communication among the components of promotion analyzer system 110. Processor 220 may include one or more processors, microprocessors, and/or processing logic (e.g., application specific integrated circuits (ASICs) or field programmable gate arrays (FPGAs)) that may interpret and execute instructions.

Memory 230 may include a random access memory (RAM) or another type of dynamic storage device that stores information and instructions for execution by processor 220, a read only memory (ROM) or another type of static storage device that stores static information and instructions for processor 220, and/or some other type of magnetic or optical recording medium and its corresponding drive for storing information and/or instructions.

Input device 240 may include a device that permits an operator to input information to promotion analyzer system 110, such as a keyboard, a keypad, a mouse, a pen, a microphone, one or more biometric mechanisms, and the like. Output device 250 may include a device that outputs information to the operator, such as one or more light indicators (e.g., light emitting diodes (LEDs)), a display, a speaker, etc.

Communication interface 260 may include any transceiver-like mechanism that enables promotion analyzer system 110 to communicate with other devices and/or systems. For example, communication interface 260 may include mechanisms for communicating with other devices, such as other devices of system 100. For example, communication interface 260 may include a modem, a network interface card, and/or a wireless interface card.

As described herein, promotion analyzer system 110 may perform certain operations in response to processor 220 executing software instructions included in a computer-readable medium, such as memory 230. A computer-readable medium may be defined as a physical or logical memory device. A logical memory device may include memory space within a single physical memory device or spread across multiple physical memory devices. The software instructions may be read into memory 230 from another computer-readable medium or from another device via communication interface 260. The software instructions included in memory 230 may cause processor 220 to perform processes described herein. Alternatively, hardwired circuitry may be used in place of or in combination with software instructions to implement processes described herein. Thus, implementations described herein are not limited to any specific combination of hardware circuitry and software.

Although FIG. 2 shows example components of promotion analyzer system 110, in other implementations, promotion analyzer system 110 may include fewer components, different components, differently arranged components, or additional components than depicted in FIG. 2. Alternatively, or additionally, one or more components of promotion analyzer system 110 may perform one or more tasks described as being performed by one or more other components of promotion analyzer system 110.

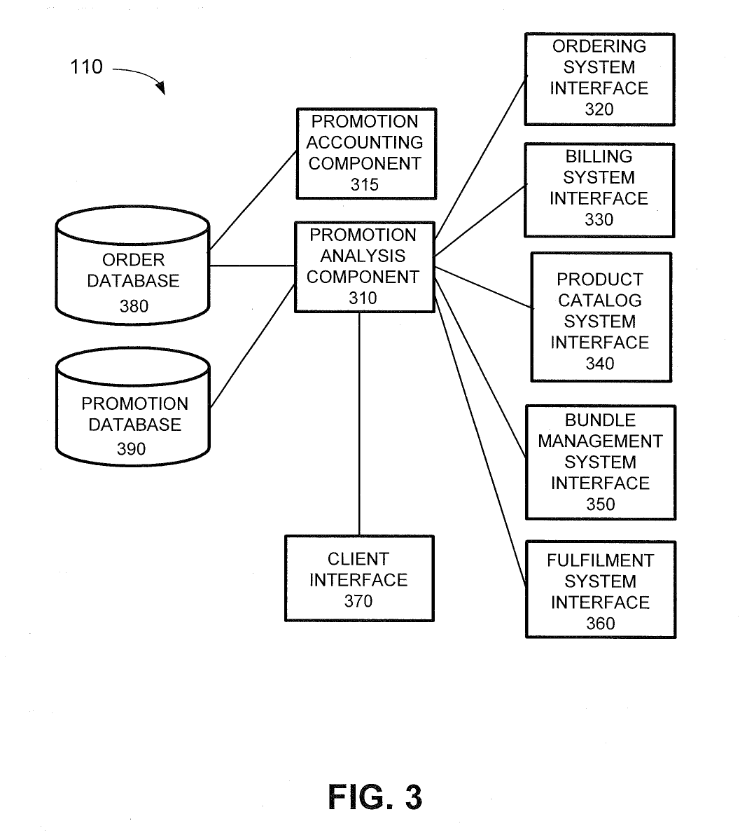

FIG. 3 is a diagram illustrating example functional components of promotion analyzer system 110 according to an implementation described herein. As shown in FIG. 3, promotion analyzer system 110 may include a promotion analysis component 310, a promotion accounting component 315, an ordering system interface 320, a billing system interface 330, a product catalog system interface 340, a bundle management system interface 350, a fulfillment system interface 360, a client interface 370, an order database 380, and a promotion database 390.

Promotion analysis component 310 may receive order information and store the order information in order database 380. Promotion analysis component 310 may determine whether a customer, associated with a customer order, is eligible for a promotion, and, when the customer is eligible for a promotion, may track promotion requirements associated with the promotion. Promotion analysis component 310 may assign a particular promotion status to an order, the promotion status defining a current status of the promotion. When the promotion requirements have been satisfied, promotion analysis component 310 may determine that the promotion is to be fulfilled and may contact fulfillment system 170 via fulfillment system interface 360.

Promotion accounting component 315 may keep track of customer orders with respect to promotion status. For example, promotion accounting component 315 may compare a total number of customer orders to a sum of customer orders associated with each type of promotion status to determine if the sum matches the total number of customer orders. If the sum does not match the total number of customer orders, promotion accounting component 315 may identify customer orders not accounted-for by checking the promotion status of each customer order.

Ordering system interface 320 may receive messages from ordering system 130, format the messages to a format compatible with promotion analysis component 310, and may provide the formatted messages to promotion analysis component 310. Ordering system interface 320 may also receive messages from promotion analysis component 310, may format the messages to a format compatible with ordering system 130, and may provide the formatted messages to ordering system 130.

Billing system interface 330 may receive messages from billing system 140, format the messages to a format compatible with promotion analysis component 310, and may provide the formatted messages to promotion analysis component 310. Billing system interface 330 may also receive messages from promotion analysis component 310, may format the messages to a format compatible with billing system 140, and may provide the formatted messages to billing system 140.

Product catalog system interface 340 may receive messages from product catalog system 150, format the messages to a format compatible with promotion analysis component 310, and may provide the formatted messages to promotion analysis component 310. Product catalog system interface 340 may also receive messages from promotion analysis component 310, may format the messages to a format compatible with product catalog system 150, and may provide the formatted messages to product catalog system 150.

Bundle management system interface 350 may receive messages from bundle management system 160, format the messages to a format compatible with promotion analysis component 310, and may provide the formatted messages to promotion analysis component 310. Bundle management system interface 350 may also receive messages from promotion analysis component 310, may format the messages to a format compatible with bundle management system 160, and may provide the formatted messages to bundle management system 160.

Fulfillment system interface 360 may receive messages from fulfillment system 170, format the messages to a format compatible with promotion analysis component 310, and may provide the formatted messages to promotion analysis component 310. Fulfillment system interface 360 may also receive messages from promotion analysis component 310, may format the messages to a format compatible with fulfillment system 170, and may provide the formatted messages to fulfillment system 170.

Client interface 370 may receive messages from client device 180, format the messages to a format compatible with promotion analysis component 310, and may provide the formatted messages to promotion analysis component 310. Fulfillment system interface 360 may also receive messages from promotion analysis component 310, may format the messages to a format compatible with fulfillment system 170, and may provide the formatted messages to fulfillment system 170.

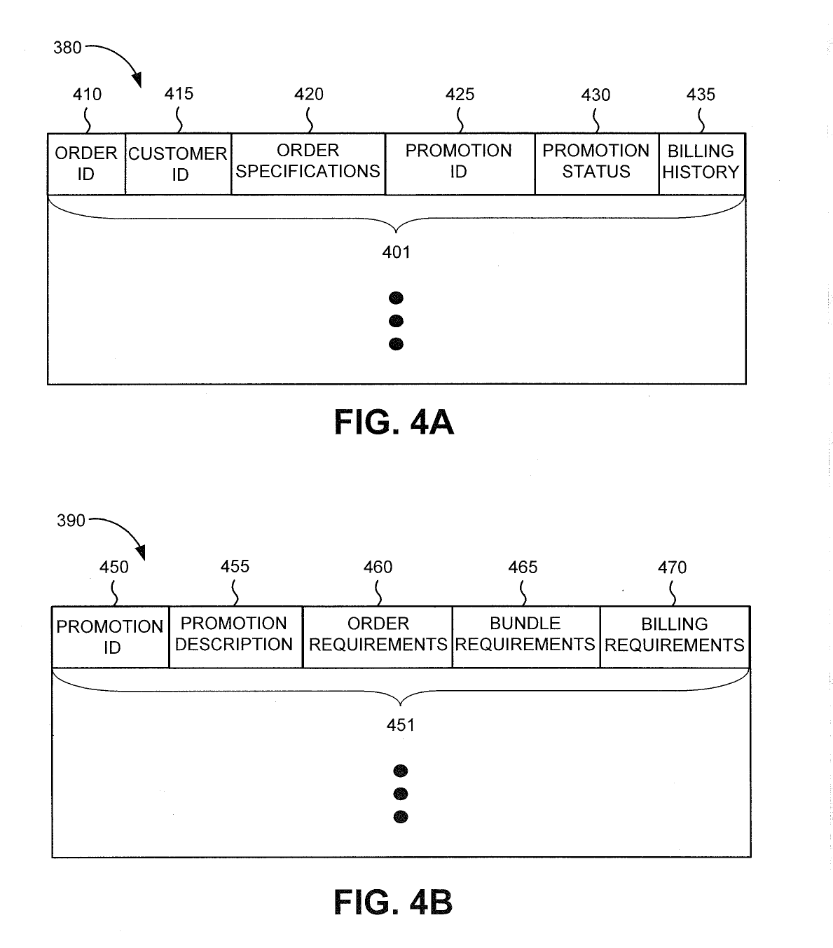

Order database 380 may store information associated with customer orders. Example fields that may be stored in order database 380 are described below with reference to FIG. 4A. Promotion database 390 may store information associated with particular promotions. Example fields that may be stored in promotion database 390 are described below with reference to FIG. 4B.

Although FIG. 3 shows example functional components of promotion analyzer system 110, in other implementations, promotion analyzer system 110 may include fewer functional components, different functional components, differently arranged functional components, or additional functional components than depicted in FIG. 3. Additionally or alternatively, one or more functional components of promotion analyzer system 110 may perform one or more tasks described as being performed by one or more other functional components of promotion analyzer system 110.

FIG. 4A is a diagram of example fields that may be stored within order database 380 according to an implementation described herein. In one implementation, order database 380 may be implemented in a storage device included as part of memory 230. In another implementation, order database 380 may be stored in a memory associated with another device or a group of devices, separate from or including memory 230. As shown in FIG. 4A, order database 380 may include one or more order records 401 (referred to herein collectively as “order records 401” and individually as “order record 401”). Order record 401 may include an order identification (ID) field 410, a customer ID field 415, an order specifications field 420, a promotion ID field 425, a promotion status field 430, and a billing history field 435.

Order ID field 410 may store an identifier string that uniquely identifies a particular customer order (e.g., a subscription for services). Customer ID field 415 may store an identifier string that uniquely identifies a customer associated with the particular order. Order specifications field 420 may store information about the particular order. For example, order specifications field 420 may include information about particular products and/or services which the customer ordered and/or to which the customer subscribes.

Promotion ID field 425 may store a string that uniquely identifies a particular promotion associated with the particular order. Promotion status field 430 may store a particular promotion status associated with the particular promotion. For example, in one implementation, promotion status field 430 may store a “not qualified” status that indicates the particular order is not qualified for any promotions; may store a “waiting for balance” status that indicates that promotion analyzer system 110 is waiting to receive information about a balance of an account associated with the particular order from billing system 140; may store a “waiting for retry” status that indicates that balance information was received from billing system 130 and that the received balance did not satisfy billing requirements associated with the particular promotion, resulting in a need for a subsequent request for balance information; may store a “canceled” status that indicates that the particular order was canceled; or may store a “succeeded” status that indicates that the particular promotion was successfully fulfilled. In another implementation, promotion status field 430 may store a promotion status indicator selected from a different set of promotion status indicators.

Billing history field 435 may store information about billing information, associated with the particular order, that was received from billing system 140. For example, whenever promotion analyzer system 110 receives billing information (e.g., an account balance) from billing system 140, the received information may be stored in billing history field 435.

Although FIG. 4A shows example fields that may be stored in order database 380, in other implementations, order database 380 may include fewer fields, different fields, differently arranged fields, and/or additional fields than depicted in FIG. 4A.

FIG. 4B is a diagram of example fields that may be stored within promotion database 390 according to an implementation described herein. In one implementation, promotion database 390 may be implemented in a storage device included as part of memory 230. In another implementation, promotion database 390 may be stored in a memory associated with another device or a group of devices, separate from or including memory 230. As shown in FIG. 4B, promotion database 390 may include one or more promotion records 451 (referred to herein collectively as “promotion records 451” and individually as “promotion record 451”). Promotion record 451 may include a promotion ID field 450, a promotion description field 455, an order requirements field 460, a bundle requirements field 465, and a billing requirements field 470.

Promotion ID field 450 may store a string that uniquely identifies a particular promotion. Promotion description field 455 may store information describing the particular promotion. For example, promotion description field 455 may store a product and or service identifier associated with the particular promotion and/or a verbal description of the particular promotion. The information stored in promotion description field 455 may be provided to fulfillment system 170 when promotion analyzer system 110 contacts fulfillment system 170.

Order requirements field 460 may store information about particular order requirements associated with the particular promotion. For example, order requirements field 460 may store indications of particular services and/or products, and/or particular levels of particular services and/or products, that may be required in order for a customer to be eligible for a particular promotion. For example, in order for a customer to be eligible for a gift card to a particular consumer electronics retailer, the customer may need to subscribe to a particular television service package.

Bundle requirements field 465 may store information about particular bundle requirements associated with the particular promotion. For example, bundle requirements field 465 may store indications of one or more particular combinations of services and/or products, and/or particular levels of particular services and/or products, that may be required in order for a customer to be eligible for a particular promotion.

Billing requirements field 470 may store information about particular billing requirements associated with the particular promotion. For example, billing requirements field 470 may store a balance threshold that indicates a maximum balance, associated with an account associated with a customer order, that will keep a customer eligible for the particular promotion. Additionally, billing requirements field 470 may include a grace period, which may indicate an amount of time that a customer is allowed to have a balance that is over the balance threshold before the customer loses eligibility for the particular promotion. Additionally, billing requirements field 470 may include a waiting period that may indicate an amount of time that must elapse before the promotion is fulfilled. Furthermore, the waiting period may be specified in combination with a particular balance threshold. For example, billing requirements field 470 may include an indication that the customer's balance must remain below $50 for at least 60 days before the particular promotion is fulfilled.

Although FIG. 4B shows example fields that may be stored in promotion database 390, in other implementations, promotion database 390 may include fewer fields, different fields, differently arranged fields, and/or additional fields than depicted in FIG. 4B.

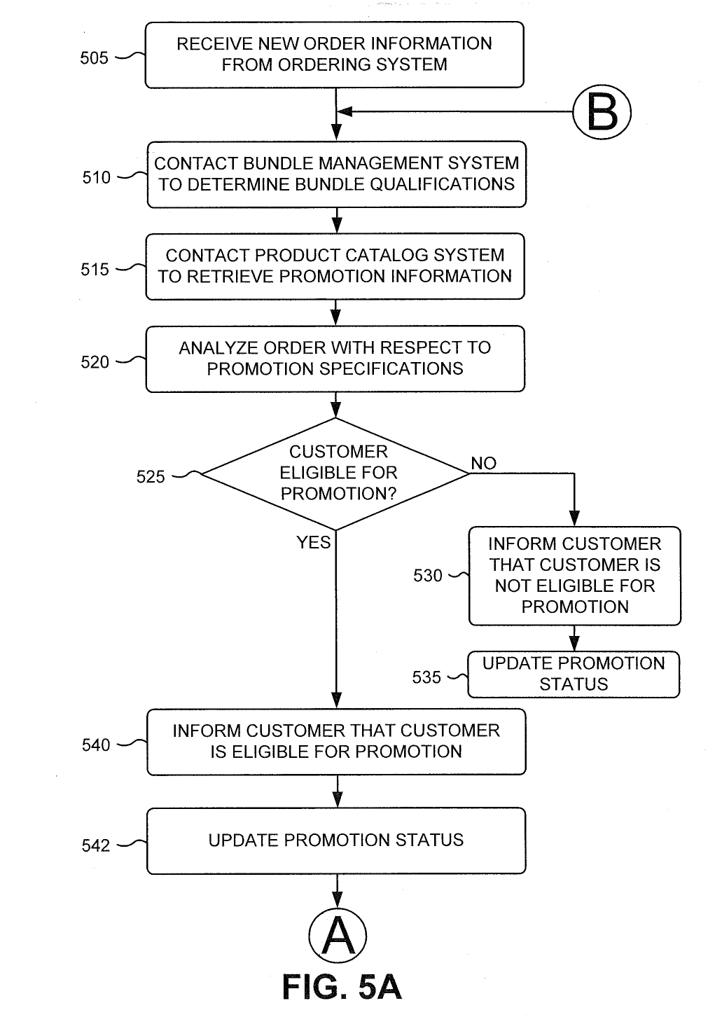

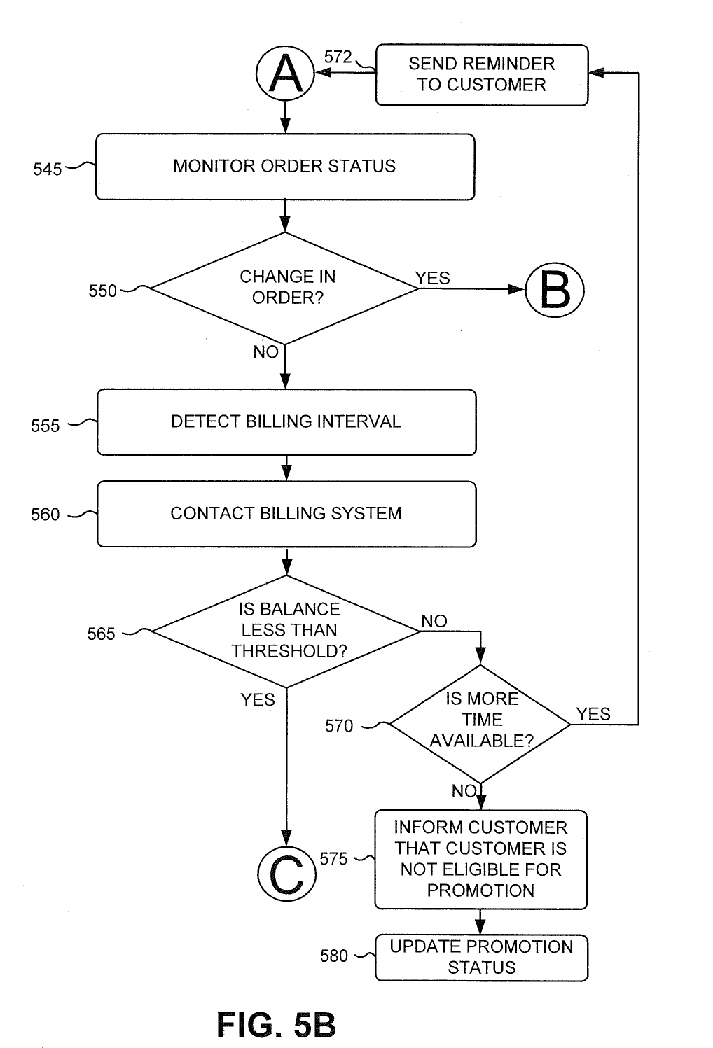

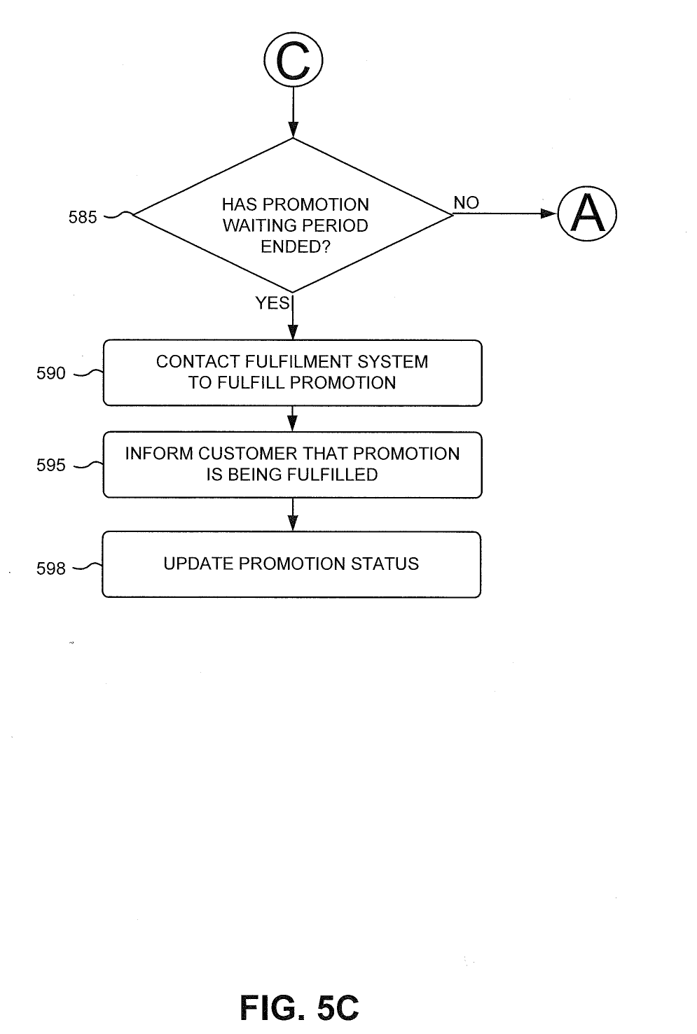

FIGS. 5A-5C are flow diagrams illustrating a process of promotion analysis according to an implementation described herein. In one implementation, the process of FIGS. 5A-5C may be performed by promotion analyzer system 110. In other implementations, some or all of the process of FIGS. 5A-5C may be performed by another device or a group of devices separate from and/or possibly remote from promotion analyzer system 110 and/or including promotion analyzer system 110.

The process of FIGS. 5A-5C may include receiving new order information from an ordering system (block 505). For example, ordering system interface 320 may receive an indication from ordering system 130 that a new customer order has been created. The indication may include information about the order, such as particular services and/or products included in the order, a particular level associated with each service and/or product, etc. Promotion analysis component 310 may create a new order record 401 in order database 380 and may store the information about the order in order specifications field 420 of the new order record 401.

A bundle management system may be contacted to determine bundle qualifications (block 510). For example, in response to receiving the indication of the new order, promotion analysis component 310 may, via bundle management system interface 350, request bundle qualifications from bundle management system 160. The request may include information about the order, such as the information received from ordering system 130. Bundle management system interface 350 may receive bundle qualifications from bundle management system 160. The bundle qualifications may specify whether the order is associated with one or more particular bundles of services and/or products, and may include information about whether the particular bundle of services is associated with a particular promotion.

A product catalog system may be contacted to retrieve promotion information (block 515). For example, promotion analysis component 310 may, via product catalog system interface 340, request promotion information from product catalog system 150. The request for promotion information may include the received order information and/or may include the received bundle qualifications information. Product catalog system interface 340 may receive promotion information from product catalog system 150. In one implementation, the promotion information may include a promotion ID and promotion analysis component 310 may store the received promotion ID in promotion ID field 425 of order record 401. Promotion analysis component 310 may use the promotion ID to identify a particular promotion in promotion database 390. In another implementation, the promotion information may include additional information, such as a promotion description, order requirements, bundle requirements, and/or billing requirements. Promotion analysis component 310 may create a new promotion record 451 in promotion database 390 and may store the received promotion information in new promotion record 451.

The order may be analyzed with respect to promotion specifications (block 520). For example, promotion analysis component 310 may compare information stored in promotion record 451 with information stored in order specifications field 420 of order record 401. A determination may be made whether a customer is eligible for promotion (block 525). For example, promotion analysis component 310 may determine whether the customer order is eligible for promotion based on the analysis. Additionally or alternatively, a promotion may be manually associated with the customer order. For example, an administrator may automatically assign a promotion to the customer order.

If it is determined that the customer is not eligible for a promotion (block 525—NO), the customer may be informed that the customer is ineligible for a promotion (block 530). For example, product catalog system 150 may not return any promotion information or may indicate that the order is not eligible for a promotion. As another example, promotion analysis component 310 may determine that the customer order is not eligible for a promotion, based on the order specifications. In one implementation, in response to determining that the customer is not eligible for a promotion, promotion analysis system 110 may, via client interface 370, send a message to the customer informing the customer that the customer is not eligible for a promotion. The message may take any form receivable by client device 180, such as an email message, an automated telephone call, or a text message. In another implementation, if it is determined that the customer is not eligible for a promotion, no message may be sent. The promotion status may be updated (block 535). For example, promotion accounting component 315 may set the promotion status to “not qualified” in promotion status field 430 of order record 401.

Returning to block 525, if it is determined that the customer is eligible for promotion (block 525—YES), the customer may be informed that the customer is eligible for promotion (block 540). For example, in response to determining that the customer is eligible for a promotion, promotion analysis system 110 may, via client interface 370, send a message to the customer informing the customer that the customer is eligible for a promotion. The message may include particular information associated with the promotion, such as a promotion description and/or promotion qualification information associated with the promotion (e.g., that the customer's balance must remain below a particular amount for a particular number of billing cycles). The message may take any form receivable by client device 180, such as an email message, an automated telephone call, or a text message.

The promotion status may be updated (block 542). For example, promotion accounting component 315 may set the promotion status to “waiting for balance” in promotion status field 430 of order record 401.

Continuing to FIG. 5B, the order status may be monitored (block 545). For example, promotion analysis component 310 may monitor the customer order. A determination may be made whether there is a change in the order (block 550). For example, promotion analysis component 310 may determine whether any changes were made to the order.

If it is determined that there is a change in the order (block 550—YES), processing may return to block 510. For example, a customer may add a service and/or a product to the order, may remove a service and/or product from the order, may modify a level of service and/or product associated with the order, or may cancel the order. Promotion analysis component 310 may detect a change in the order in response to receiving an indication of a change in the order from ordering system 130. If ordering system informs promotion analyzer system 110 that the customer has canceled the order, promotion accounting component 315 may set the promotion status to “canceled” in promotion status field 430 of order record 401.

If it is determined that there is no change in the order (block 550—NO), a billing interval may be detected (block 555). For example, promotion analysis component 310 may wait until a billing interval has ended (e.g., by checking billing history field 435 of order record 401). A billing system may be contacted (block 560). For example, promotion analysis component 310 may, via billing system interface 330, request balance information, associated with the customer order, from billing system 140. Billing system 140 may send a balance, associated with the customer order, to promotion analyzer system 110.

A determination may be made whether a balance associated with the order is less than a threshold (block 565). For example, promotion analysis component 310 may compare the received balance with information stored in billing requirements field 470 of promotion record 451 associated with the customer order. Billing requirements field 470 may include a balance threshold that must be satisfied in order for the customer to remain eligible for the promotion.

If it is determined that the balance is not less than the threshold (block 565—NO), a determination may be made whether there is more time available (block 570). For example, a customer may be given additional time to pay and reduce the customer's balance below the threshold. For example, billing requirements field 470 may include, in addition to a billing threshold, a grace period in which the customer may bring down the balance to below the balance threshold.

If it is determined that more time is available (block 570—YES), a reminder may be sent to the customer (block 572) and processing may return to block 545. For example, promotion analysis component 310 may send, via client interface 370, a message to client device 180, reminding the customer that the customer needs to pay the customer's bill or the customer may lose the promotion. The message may include information about how much time the customer has to pay before the promotion offer is withdrawn. The message may take any form receivable by client device 180, such as an email message, an automated telephone call, or a text message. Promotion accounting component 315 may set the promotion status to “waiting for retry” in promotion status field 430 of order record 401.

If it is determined that no more time is available (block 570—NO), the customer may be informed that the customer is not eligible for a promotion (block 575) and the promotion status may be updated (block 580). For example, promotion analysis system 110 may, via client interface 370, send a message to client device 180, informing the customer that the customer is no longer eligible for a promotion. The message may take any form receivable by client device 180, such as an email message, an automated telephone call, or a text message. Promotion accounting component 315 may set the promotion status to “not qualified” in promotion status field 430 of order record 401.

Returning to block 565, if it is determined that the balance is less than the threshold (block 565—YES), continuing to FIG. 15C, a determination may be made whether a promotion waiting period has ended (block 585). For example, there may be a waiting period associated with a promotion. As an example, a promotion may not be fulfilled until the customer has paid a bill associated with the order for a particular number of billing cycles. Information regarding the waiting period may be stored, for example, in billing requirements field 470 of promotion order 451.

If it is determined that the waiting period has not ended (block 585—NO), processing may return block 545. If it is determined that the waiting period has ended (block 585—YES), a fulfillment system may be contacted to fulfill the promotion (block 590). For example, promotion analysis component 310 may contact, via fulfillment system interface 360, fulfillment system 170, instructing fulfillment system 170 to fulfill the promotion. Promotion analysis component 310 may receive a confirmation from fulfillment system 170 that the promotion has been fulfilled.

The customer may be informed that the promotion is being fulfilled (block 595). For example, promotion analysis component 310 may, via client interface 370, send a message to client device 180, informing the customer that the promotion is being fulfilled. The message may take any form receivable by client device 180, such as an email message, an automated telephone call, or a text message.

The promotion status may be updated (block 598). For example, promotion accounting component 315 may set the promotion status to “succeeded” in promotion status field 430 of order record 401.

While not shown in FIGS. 5A-5C, in one implementation, a customer may contact, via client device 180, promotion analyzer system 110 while a promotion is pending to request information associated with the promotion, such as when the promotion is expected to be fulfilled or what the requirements associated with the promotion are. In response to receiving the request, promotion analyzer system 110 may provide the requested information to client device 180.

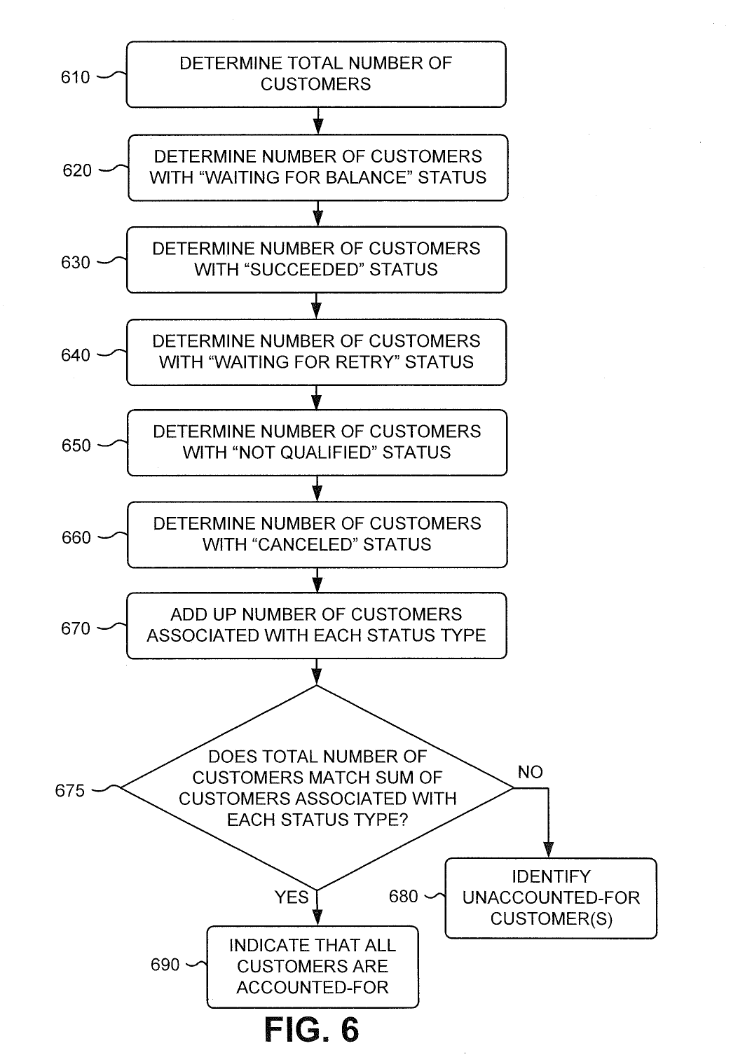

FIG. 6 is a flow diagram illustrating a process for promotion accounting according to an implementation described herein. In one implementation, the process of FIG. 6 may be performed by promotion analyzer system 110. In other implementations, some or all of the process of FIG. 6 may be performed by another device or a group of devices separate from and/or possibly remote from promotion analyzer system 110 and/or including promotion analyzer system 110. In one implementation, the process of FIG. 6 may be initiated by an administrator performing a check of promotions associated with customer orders. In another implementation, the process of FIG. 6 may be performed automatically (e.g., at particular intervals).

The process of FIG. 6 may include determining a total number of customers (block 610). For example, in one implementation, promotion accounting component 315 may determine a total number of order records 401 in order database 380. In another implementation, promotion accounting component 315 may determine a total number of customers using another technique.

A number of customers with “waiting for balance” status may be determined (block 620). For example, in one implementation, promotion accounting component 315 may determine a total number of order records 401, with a “waiting for balance” status recorded in promotion status field 430, in order database 380. In another implementation, promotion accounting component 315 may determine a number of customers with a “waiting for balance” status via another technique.

A number of customers with “succeeded” status may be determined (block 630). For example, in one implementation, promotion accounting component 315 may determine a total number of order records 401, with a “succeeded” status recorded in promotion status field 430, in order database 380. In another implementation, promotion accounting component 315 may determine a number of customers with a “succeeded” status via another technique.

A number of customers with “waiting for retry” status may be determined (block 640). For example, in one implementation, promotion accounting component 315 may determine a total number of order records 401, with a “waiting for retry” status recorded in promotion status field 430, in order database 380. In another implementation, promotion accounting component 315 may determine a number of customers with a “waiting for retry” status via another technique.

A number of customers with “not qualified” status may be determined (block 650). For example, in one implementation, promotion accounting component 315 may determine a total number of order records 401, with a “not qualified” status recorded in promotion status field 430, in order database 380. In another implementation, promotion accounting component 315 may determine a number of customers with a “not qualified” status via another technique.

A number of customers with “canceled” status may be determined (block 660). For example, in one implementation, promotion accounting component 315 may determine a total number of order records 401, with a “canceled” status recorded in promotion status field 430, in order database 380. In another implementation, promotion accounting component 315 may determine a number of customers with a “canceled” status via another technique.

The number of customers associated with each status type may be added up (block 670). For example, promotion accounting component 315 may add up the number of customers associated with a “waiting for balance” status, the number of customers associated with a “succeeded” status, the number of customers associated with a “waiting for retry” status, the number of customers associated with a “not qualified” status, and the number of customers associated with a “canceled” status.

A determination may be made whether a total number of customers matches the sum of customers associated with each status type (block 675). For example, promotion accounting component 315 may determine whether the total number of order records 401 matches the sum of order records 401 associated with each possible status that may be recorded in promotion status field 430 of order records 401.

If it is determined that the total number of customers matches the sum of customers associated with each status type (block 675—YES), an indication may be made that all customers are accounted-for (block 690). For example, promotion accounting component 315 may provide an indication that all customers are accounted-for to an administrator performing a status check (e.g., via output device 250 and/or via communication interface 260).

If it is determined that the total number of customers does not match the sum of customers associated with each status type (block 675—NO), unaccounted-for customers may be identified (block 680). For example, promotion accounting component 315 may search through order records 401 to identify order records 401 not associated with any of the status types and may provide an indication of the identified order records 401 to an administrator (e.g., via output device 250 and/or via communication interface 260).

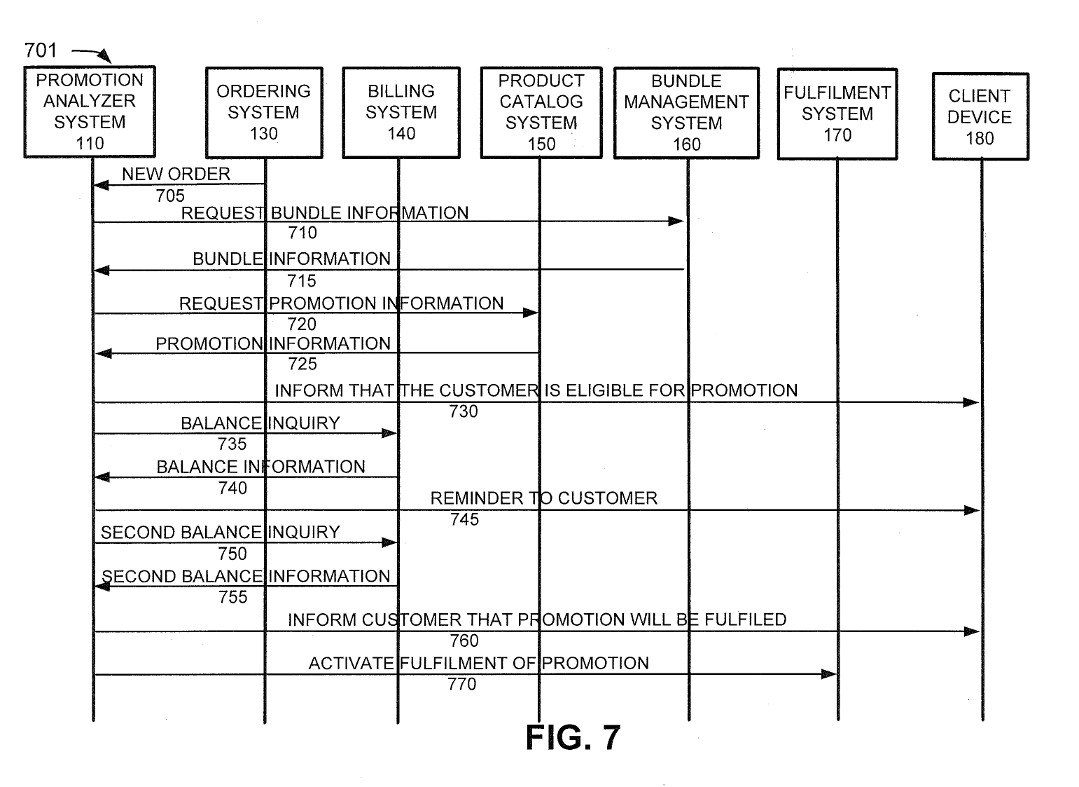

FIG. 7 is a diagram illustrating an example signal flow 701 according to an implementation described herein. Signal flow 701 illustrates the process of FIGS. 5A-5C in the context of system 100. Signal flow 701 may include ordering system 130 sending information about a new order to promotion analyzer system (signal 705). For example, assume the customer has subscribed to a wireless voice plan and a wireless data plan.

Promotion analyzer system 110 may request bundle information from bundle management system 160 (signal 710) and bundle management system may provide the bundle information to promotion analyzer system 110, in response to receiving the request for the bundle information (signal 715). For example, assume that the wireless voice plan and the wireless data plan are identified with a particular service bundle.

Promotion analyzer system 110 may request promotion information from product catalog system 150 (signal 720) and product catalog system 150 may provide the promotion information to promotion analyzer system 110, in response to receiving the request for the promotion information (signal 725). For example, assume product catalog system 150 returns three available promotions, a gift card to an electronics store, a free mobile phone accessory, and a free upgrade to wireless data plan with a higher data rate, along with particular requirements associated with each promotion. Promotion analyzer system 110 may store the received promotion information in promotion database 390. Promotion analyzer system 110 may determine that, based on the particular service bundle that includes the wireless voice plan and the wireless data plan, the customer is eligible for the gift card to the electronics store.

Promotion analyzer system 110 may inform the customer that the customer is eligible for the promotion by, for example, sending an email message to client device 180 (signal 730). Promotion analyzer system 110 may wait until a billing cycle ends and, when the billing cycle ends, may send a balance inquiry to billing system 140 (signal 735). In response to receiving the balance inquiry, billing system 140 may send balance information to promotion analyzer system 110 (signal 740). Assume the balance associated with the customer's account is $75 and assume that the billing requirements associated with the gift card include a balance of less than $50 for at least 30 days.

Promotion analyzer system 110 may send a message to the customer, by for example, sending an email to client device 180, reminding the customer that to remain eligible for the promotion, the customer needs to pay the customer's bill (signal 745). Promotion analyzer system 110 may wait until another billing cycle elapses and, when the next billing cycle elapses, may send a second balance inquiry to billing system 140 (signal 750). In response to receiving the second balance inquiry, billing system 140 may send second balance information to promotion analyzer system 110 (signal 755). Assume the balance associated with the customer's account is $0.

Based on receiving the second balance information, promotion analyzer system 110 may determine that the promotion requirements have been satisfied and may determine that the promotion is to be fulfilled. In response to the determination, promotion analyzer system 110 may inform the customer that the promotion is being fulfilled by, for example, sending an email message to client device 180 (signal 760). Furthermore, promotion analyzer system 110 may send a signal to fulfillment system 170 to fulfill the promotion (e.g., to mail the gift card to the customer) (signal 770).

The foregoing description of implementations, described above, provides illustration and description, but is not intended to be exhaustive or to limit the invention to the precise form disclosed. Modifications and variations are possible in light of the above teachings or may be acquired from practice of the invention.

For example, while series of blocks have been described with regard to FIGS. 5A-5C and 6, the order of the blocks may be modified in other implementations. Further, non-dependent blocks may be performed in parallel.

Also, certain portions of the implementations may have been described as a “component” or “interface” that performs one or more functions. The terms “component” and “interface” may include hardware, such as a processor, an ASIC, or a FPGA, or a combination of hardware and software (e.g., software running on a processor).

It will be apparent that aspects described herein may be implemented in many different forms of software, firmware, and hardware in the implementations illustrated in the figures. The actual software code or specialized control hardware used to implement aspects does not limit the embodiments. Thus, the operation and behavior of the aspects were described without reference to the specific software code—it being understood that software and control hardware can be designed to implement the aspects based on the description herein.

Even though particular combinations of features are recited in the claims and/or disclosed in the specification, these combinations are not intended to limit the disclosure of the invention. In fact, many of these features may be combined in ways not specifically recited in the claims and/or disclosed in the specification.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method performed by a server device, the method comprising:
receiving, by the server device, information about a customer order, associated with a particular service or product provider, from an ordering system;
determining, by the server device, whether the customer order is eligible for a promotion based on the received information, where the promotion includes a reward to a customer for placing the customer order;
requesting, by the server device, balance information associated with the customer order from a billing system, when the customer order is eligible for the promotion;
receiving, by the server device, a balance amount, associated with the customer order, from the billing system;
determining, by the server device, whether the balance amount is less than a balance threshold; and
sending, by the server device, a message to a fulfillment system to fulfill the promotion, when the balance amount is less than the balance threshold.

2. The method of claim 1, further comprising:
receiving bundle information associated with the received customer order from a bundle management system, where the bundle management system maintains information about particular groupings of services or products associated with the particular service or product provider; and
where determining whether the customer order is eligible for a promotion is further based on the received bundle information.

3. The method of claim 1, further comprising:
receiving promotion information from a product catalog system, where the product catalog system maintains information about available promotions; and
where determining whether the customer order is eligible for a promotion is further based on the received promotion information.

4. The method of claim 3, where the received promotion information includes one or more of:
information describing the promotion;
order requirements information that includes an indication of a particular service or product, or a particular level of the particular service or product, that needs to be included in the customer order in order for the customer order to be eligible for the promotion;
bundle requirements information that includes an indication of a particular grouping of particular services or products, or of particular levels of particular services or products, that needs to be included in the customer order in order for the customer to be eligible for the promotion; or
billing requirements information that includes an indication of a particular billing balance amount that must be satisfied in order for the customer to be eligible for the promotion.

5. The method of claim 1, further comprising:
sending, when the customer order is eligible for the promotion, a message to a client device, associated with the customer order, the message informing the customer that the customer order is eligible for the promotion.

6. The method of claim 1, further comprising:
determining that the balance amount is not less than the balance threshold;
determining that more time is available to reduce the balance amount, in response to determining that the balance amount is not less than the balance threshold; and
sending a message to a client device, associated with the customer order, the message including a reminder to the customer to pay a bill associated with the customer order, in response to determining that more time is available to reduce the balance amount.

7. The method of claim 6, further comprising:
waiting until a particular amount of time has elapsed;
requesting second balance information associated with the customer order from the billing system, when the particular time has elapsed;
receiving, by the server device, a second balance amount, associated with the customer order, from the billing system;
determining whether the second balance amount is less than a balance threshold; and
sending a message to a fulfillment system to fulfill the promotion, when the second balance amount is less than the balance threshold.

8. The method of claim 1, further comprising:
determining that the balance amount is not less than the balance threshold;
determining that no more time is available to reduce the balance amount, in response to determining that the balance amount is not less than the balance threshold;
sending, in response to determining that more time is available to reduce the balance amount, a message to a client device, associated with the customer order, the message informing the customer that the customer order is no longer eligible for the promotion; and
indicating, in an order record associated with the customer order, that the customer order is not longer eligible for the promotion.

9. The method of claim 1, further comprising:
detecting a change in the customer order by receiving new information about the customer order from the ordering system; and
determining whether the customer order is eligible for a promotion based on the received new information.

10. The method of claim 1, further comprising:
determining whether a waiting period associated with the promotion has ended; and
where the sending the message to the fulfillment system to fulfill the promotion is performed when the waiting period has ended.

11. The method of claim 1, further comprising:
associating a promotion status type with the customer order selected from a set of promotion status types;
determining a total quantity of customer orders associated with the server device;
determining a quantity of customer orders associated with each particular promotion status type in the set of promotion status types;
adding up the quantity of customer orders associated each particular promotion status type for all promotion types in the set of promotion status types; and
determining whether the total quantity of customer orders matches the added up quantity of customer orders.

12. The method of claim 11, where the set of promotion status types includes one or more of:
a first promotion status type to indicate that the customer order is not eligible for the promotion;
a second promotion status type to indicate that the server device is waiting to receive the balance amount associated with the customer order;
a third promotion status type to indicate that the server device is waiting to receive a second balance amount associated with the customer order;
a fourth balance type to indicate that the customer order has been canceled; and
a fifth balance type to indicate that the promotion has been fulfilled.

13. A server device comprising:
a memory to store instructions; and
a processor to execute the instructions to:
receive information about a customer order, associated with a particular service or product provider, from an ordering system;
determine whether the customer order is eligible for a promotion based on the received information, where the promotion includes a reward to a customer for placing the customer order;
request balance information associated with the customer order from a billing system, when the customer order is eligible for the promotion;
receive a balance amount, associated with the customer order, from the billing system;
determine whether the balance amount is less than a balance threshold; and
send a message to a fulfillment system to fulfill the promotion, when the balance amount is less than the balance threshold.

14. The server device of claim 13, where the processor is further to:
receive bundle information associated with the received customer order from a bundle management system, where the bundle management system maintains information about particular groupings of services or products associated with the particular service or product provider; and
where the processor is to further determine whether the customer order is eligible for a promotion based on the received bundle information.

15. The server device of claim 13, where the processor is further to:
receive promotion information from a product catalog system, where the product catalog system maintains information about available promotions; and
where the processor is further to determine whether the customer order is eligible for a promotion based on the received promotion information.

16. The server device of claim 13, where the processor is further to:
send, when the customer order is eligible for the promotion, a message to a client device, associated with the customer order, the message informing the customer that the customer order is eligible for the promotion.

17. The server device of claim 13, where the processor is further to:
determine that the balance amount is not less than the balance threshold;
determine that more time is available to reduce the balance amount, in response to determining that the balance amount is not less than the balance threshold; and
send, in response to determining that more time is available to reduce the balance amount, a message to a client device, associated with the customer order, the message including a reminder to the customer to pay a bill associated with the customer order.

18. The server device of claim 13, where the processor is further to:
determine that the balance amount is not less than the balance threshold;
determine that no more time is available to reduce the balance amount, in response to determining that the balance amount is not less than the balance threshold;
send, in response to determining that more time is available to reduce the balance amount, a message to a client device, associated with the customer order, the message informing the customer that the customer order is no longer eligible for the promotion; and
indicating, in an order record associated with the customer order, that the customer order is no longer eligible for the promotion.

19. The server device of claim 13, where the processor is further to:
detect a change in the customer order by receiving new information about the customer order from the ordering system; and
determine whether the customer order is eligible for a promotion based on the received new information.

20. A computer-readable medium storing instructions executable by a processor, the computer-readable medium comprising:
one or more instructions to receive information about a customer order, associated with a particular service or product provider;
one or more instructions to determine whether the customer order is eligible for a promotion based on the received information, where the promotion includes a reward to a customer for placing the customer order;
one or more instructions to request balance information associated with the customer order from a billing system, when the customer order is eligible for the promotion;
one or more instructions to receive a balance amount, associated with the customer order, from the billing system;
one or more instructions to determine whether the balance amount is less than a balance threshold; and
one or more instructions to send a message to a fulfillment system to fulfill the promotion, when the balance amount is less than the balance threshold.
